(19) United States
(12) Patent Application Publication
(10) Pub. No.: US 2010/0311528 A1
(43) Pub. Date: Dec. 9, 2010

(54) FILAMENTARY FABRIC ARTICLE

(76) Inventor: RUTH GOLDEN-MORACE, Arlington, TX (US)

Correspondence Address: MALDJIAN & FALLON LLC, 36 BINGHAM AVENUE, RUMSON, NJ, 07760, US

(21) Appl. No.: 12/794,802

(22) Filed: Jun. 7, 2010

Related U.S. Application Data
(60) Provisional application No. 61/185,029, filed on Jun. 8, 2009.

(51) Int. Cl. A63B 43/00; A63B 45/00

(52) U.S. Cl. 473/614; 28/143

(57) ABSTRACT

Embodiments of the present invention generally relate to a filamentary fabric article and methods of manufacturing the same. In one embodiment of the present invention, a filamentary fabric article consists of a plurality of elongated partially rolled fabric tubes, wherein the plurality of elongated partially rolled fabric tubes are sewn together at a central core region, and wherein the plurality of elongated partially rolled fabric tubes are provided in a sufficient density that the filamentary fabric article substantially resembles a generally spherical article when no external forces are acting thereon.

### CROSS-REFERENCE TO RELATED APPLICATIONS

This application claims priority to pending U.S. Provisional Application Ser. No. 61/185,029, filed Jun. 8, 2009, entitled “Filamentary Fabric Article,” the disclosure of which is incorporated herein by reference in its entirety.

### BACKGROUND OF THE INVENTION

1. Field of the Invention

Embodiments of the present invention generally relate to a filamentary fabric article. More specifically, embodiments of the present invention relate to a filamentary fabric article and methods of manufacturing the same.

2. Description of Related Art

A variety of methods and apparatus have been devised to occupy the attention of children, many of them in the form of projectile toys. Several of such toys have been in the form of a ball, generally having a smooth surface and a substantially rigid core. While such toys are enjoyable to many children, developmentally challenged children, or those with motor control deficiencies, may get frustrated by not being able to catch the toy, or even hurt by the toy should the child miss catching the toy and it impacts the child in the face, head or other undesirable body part.

Certain projectile toys have been developed with elastomeric fibers surrounding a rigid core. While such elastomeric fibers reduce the frustration aspect of the above-identified problem, the use of elastomeric fibers inherently requires the existence of a rigid core, thus leaving the harm issue unresolved. Accordingly, there is a need for a filamentary fabric article as disclosed herein.

### SUMMARY OF THE INVENTION

Embodiments of the present invention generally relate to a filamentary fabric article and methods of manufacturing the same. In one embodiment of the present invention, a filamentary fabric article consists of a plurality of elongated partially rolled fabric tubes, wherein the plurality of elongated partially rolled fabric tubes are sewn together at a central core region, and wherein the plurality of elongated partially rolled fabric tubes are provided in a sufficient density that the filamentary fabric article substantially resembles a generally spherical article when no external forces are acting thereon.

In another embodiment of the present invention, a filamentary fabric article comprises a plurality of elongated partially rolled tubes made of a stretch velour knit fabric, each of the plurality of elongated partially rolled tubes having an unrolled width of about one inch to about two inches wide, wherein the plurality of elongated partially rolled tubes are sewn together using a triple stitch at a central core region, and wherein the plurality of elongated partially rolled fabric tubes are provided in a sufficient density that the filamentary fabric article substantially resembles a generally spherical article when no external forces are acting thereon.

In yet another embodiment of the present invention, a method of manufacturing a filamentary fabric article comprises providing a blank of material, cutting the blank of material into strips of material, each strip of material having a width of between about one-quarter inch to about twelve inches, rolling each of the strips of material into an elongated partially rolled tube, creating a plurality of elongated partially rolled tubes, and binding the plurality of elongated partially rolled tubes at a central core region, wherein the plurality of elongated partially rolled fabric tubes are provided in a sufficient density that the resulting filamentary fabric article substantially resembles a generally spherical article when no external forces are acting thereon.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depict a side view of a filamentary fabric article, in accordance with embodiments of the present invention;

FIG. 2 depicts a close-up perspective view of partially rolled and stretched tubes utilized to form a filamentary fabric article in accordance with one embodiment of the present invention;

FIG. 3 depicts a top view of a blank of material in accordance with an embodiment of the present invention;

FIG. 4 depicts a top view of a plurality of strips of material in accordance with an embodiment of the present invention;

FIG. 5 depicts a top view of a plurality of individual partially rolled tubes in accordance with embodiments of the present invention;

FIG. 6 depicts a perspective view of a basic formation of a filamentary fabric article in accordance with embodiments of the present invention; and

FIG. 7 depicts a flowchart of a method of manufacturing a filamentary fabric article in accordance with one embodiment of the present invention.

The headings used herein are for organizational purposes only and are not meant to be used to limit the scope of embodiments of the present invention. As used throughout this application, the word “may” is used in a permissive sense (i.e., meaning having the potential to), rather than the mandatory sense (i.e., meaning must). Similarly, the words “include”, “including”, and “includes” mean including, but not limited to. To facilitate understanding, like reference numerals have been used, where possible, to designate like elements common to the figures.

### DETAILED DESCRIPTION

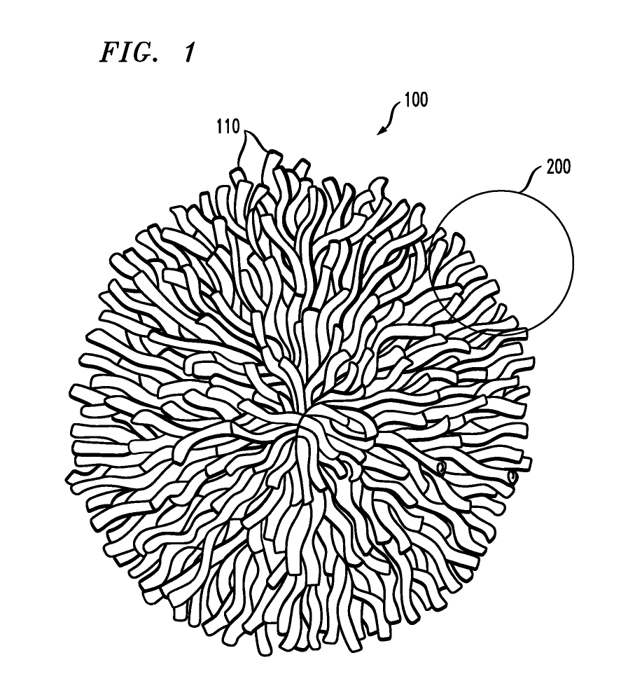

FIG. 1 depict a side view of a filamentary fabric article, in accordance with embodiments of the present invention. The filamentary fabric article 100 generally comprises a plurality of elongated partially rolled tubes 110 bound together at a central core, generally creating a substantially spherical object. In many embodiments, the materials utilized to manufacture the filamentary fabric article 100 are such that the partially rolled tubes 110 are substantially flexible, adapting shape to any forces acting thereon. Accordingly, while the exemplary filamentary fabric article 100 shown in FIG. 1 is substantially spherical object, such spherical shape would take form in the absence of any natural or unnatural forces acting thereon (e.g., in a vacuum).

In accordance with embodiments of the present invention, the filamentary fabric article 100 may be utilized for a significant number of different purposes. For example, in one embodiment, the filamentary fabric article 100 may be utilized as a throwing toy for children, adults and/or pets. Generally, when utilized as a throwing toy, the partially rolled tubes 110 are sufficiently flaccid to collapse significantly on impact, thus absorbing enough energy to avoid any tendency to bounce. In addition, in many embodiments, the partially rolled tubes 110 are provided in a sufficiently dense quantity per surface that a large plurality thereof tend to thread their way between adjacent fingers of a user's hand upon contact of the filaments with the hand during the act of catching.

In another embodiment, the filamentary fabric article 100 may be utilized as a decorative pillow or similar decorative device. In alternative embodiments of the present invention, character heads, bodies, faces, etc., in the form of plush toys or rigid polymer figures, may also be bundled with the filamentary fabric article 100. In such embodiments, any plausible number of creations, toys, etc., may be made using the general nature and teachings of embodiments of the present invention.

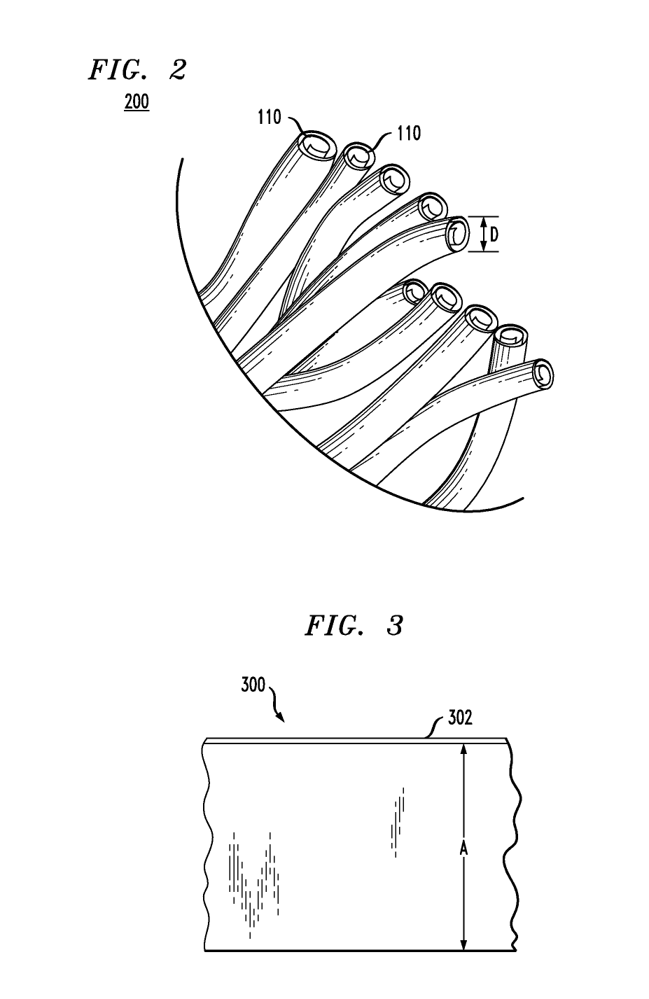

A close-up perspective view of the partially rolled tubes 110, as identified in FIG. 1 by Section 200, is shown in FIG. 2. As shown in FIG. 2, the partially rolled tubes 110 generally comprise a plurality of elongated rolls of a flat material. Generally, each partially rolled tube 110 is wound substantially tight, such that a diameter D of the partially rolled tube 110 is significantly smaller (e.g., at least one-fifth) the length of a partially rolled tube 110. However, in accordance with various embodiments of the present invention, the dimensions and ratios of dimensions of various characteristics of the filamentary fabric article 100 may be provided in any value, provided such value would render the filamentary fabric article 100 suitable for embodiments disclosed herein.

FIG. 3 depicts a top view of a blank of material in accordance with an embodiment of the present invention. In many embodiments of the present invention, the blank of material 300 comprises a cloth fabric. In some embodiments, the cloth fabric comprises a woven or non-woven fabric, either natural or synthetic, or combinations thereof. In one embodiment, the cloth fabric comprises stretch velour knit fabric. Alternative materials, having suitable properties, are also contemplated by embodiments of the present invention for use as the blank of material 300.

In accordance with one embodiment of the present invention, the cloth fabric comprises a straight grain (i.e., in the direction of the fibers) and a cross-grain (i.e., in the direction. As shown in the embodiment depicted in FIG. 3, the straight grain runs parallel to a selvage edge 302 or stitched edge of the fabric, and the cross grain runs perpendicular to the selvage edge 302.

In certain embodiments, because of the nature of a stretch woven fabric, the straight grain of the fabric has little to no stretch, whereas the cross grain is capable of stretching. Generally, the amount of stretch suitable for embodiments of the present invention is variable depending upon the nature and type of fabric being used. In accordance with embodiments of the present invention, any amount of stretch ranging from negligible to non-permanent deformation (i.e., up to the material yield point) of the fabric, is deemed suitable for embodiments of the present invention.

Because embodiments of the present invention are generally created from a large blank of fabric, the blank of material 300 is generally cut from a larger blank of material to create a suitably-sized piece of fabric as shown in the Figure. In accordance with embodiments of the present invention, the size of the filamentary fabric article may be determined by the length A of the blank of material 300. Although any length of fabric is suitable for embodiments of the present invention, many embodiments of the present invention provide a length A of the cloth fabric between three inches and twenty-four inches long. In one embodiment, the length A of the cloth fabric comprises between 2 inches and 24 inches. In another embodiment, the length A may comprise between about 4 inches to about 12 inches. In yet another embodiment, the length A comprises between about 6 inches to about 15 inches.

FIG. 4 depicts a top view plurality of strips of material in accordance with an embodiment of the present invention. Generally, when cutting the blank of material 300, the selvage edge is removed because it inherently restrains the ability to stretch to the same extent as the cross grain of the remainder of the material. As shown in the Figure, the blank of material 300 may be cut along lines 420, to create strips of material 410.

In many embodiments, the individual strips of material 410 are cut along the cross grain of a cloth fabric. For many embodiments, the width of the strips of material 410 may range from as narrow as about one-quarter inch to as wide as twelve inches. In other embodiments, the width of each strip of material 410 may be between about one inch to about two inches. In one exemplary embodiment, the width of the strips of material 410 is about one and one-quarter inches wide.

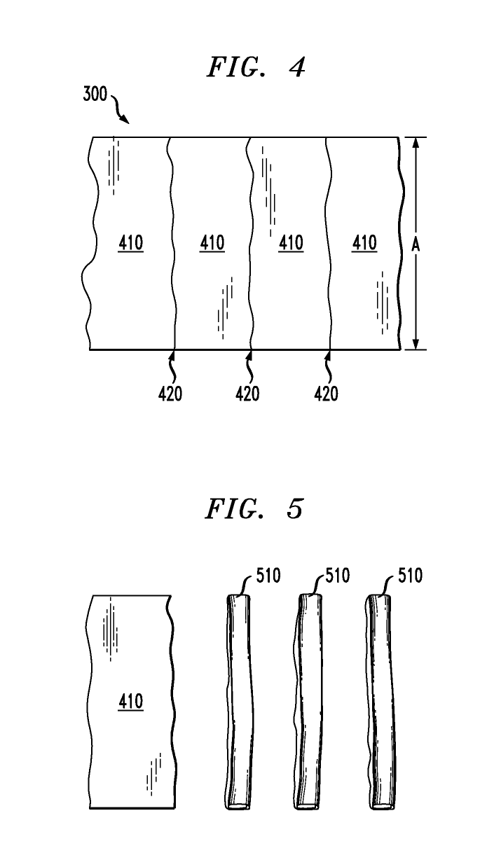

FIG. 5 depicts a top view of a plurality of individual partially rolled tubes in accordance with embodiments of the present invention. Generally, to create the partially rolled tubes 510, each of the individual strips of material 410 is pulled in a lengthwise direction, causing the individual strip of material 410 to roll and curl about itself. As understood by embodiments of the present invention, the amount of stretch in the cross grain of the material (e.g., cloth fabric) will determine the ability of the material to roll and curl about itself when stretched. In accordance with embodiments of the present invention, any amount of curl (i.e., how tightly the material is rolled about itself to create the partially rolled tube 510) is suitable for embodiments of the present invention.

Generally, as the partially rolled tubes are created, the length of the individual strips of material 410 increases significantly, caused by the tensile force placed on the material when being rolled. In accordance with embodiments of the present invention, the length of the partially rolled tubes 510 increases between about 5% to about 50% after it has rolled and curled about itself, as compared to the strip of material 410.

It should be noted, in certain embodiments, the strip of material 410 may merely be rolled about itself by taking a first edge and rolling the material inside itself to create the partially rolled tubes 510. Similarly, any other plausible means for creating a partially rolled tube 510 having the characteristics of embodiments of the present invention is deemed suitable for embodiments of the present invention.

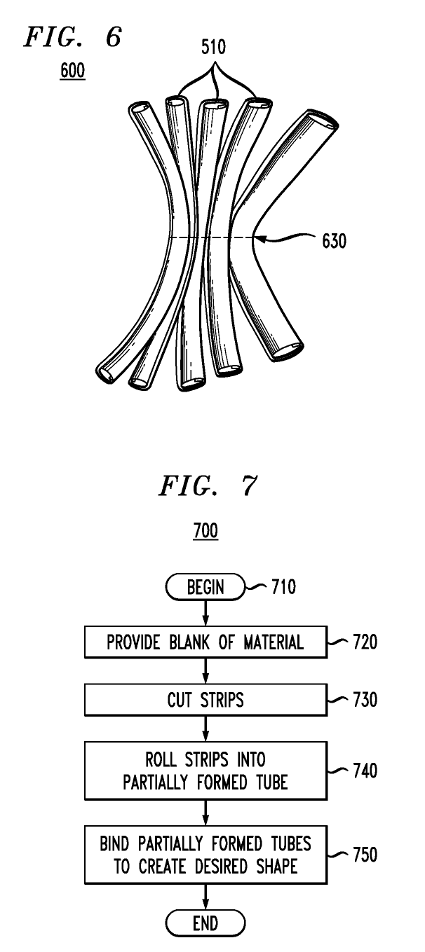

FIG. 6 depicts a perspective view of a basic formation of a filamentary fabric article in accordance with embodiments of the present invention. In many embodiments, individual partially rolled tubes 510, which are created from the individual strips of material, may be grouped with other individual rolled filaments in a linear fashion as shown in the Figure. As shown, the partially rolled tubes 510 are often positioned adjacent and aligned with one another. In one embodiment, the group of individual rolled filaments is subsequently sewn together at a centralized area 630 in such a fashion to prevent it from pulling apart. Generally, the sewing may be done by hand or by machine. The stitching may comprise a triple stitch, or any other type of stitch suitable for embodiments of the present invention.

In many embodiments, the bundling of the partially rolled tubes 510 generally comprises compacting a center 630 of the bundle of partially rolled tubes and stitching them together until the article begins to generally take a desired shape of the filamentary fabric article. In many embodiments, the desired shape is substantially spherical. As understood by embodiments of the present invention, however, because of the nature of flaccid fabric, the general shape of the article will also be subject to the positioning of the article, and the forces acting thereon.

FIG. 7 depicts a flowchart of a method of manufacturing a filamentary fabric article in accordance with one embodiment of the present invention. The method 700 begins at step 710. At step 720, a blank of material is provided. In many embodiments, the blank of material comprises a woven or non-woven, natural or synthetic fabric, or combinations thereof. In one embodiment, the blank of material comprises stretch velour knit fabric.

At step 730, the blank of material is cut into strips of material. For many embodiments, the width of the strips of material may range from as narrow as about one-quarter inch to as wide as twelve inches. In other embodiments, the width of each strip of material may be between about one inch to about two inches. In one exemplary embodiment, the width of the strips of material is about one and one-quarter inches wide.

At step 740, each of the strips of material are rolled into an elongated partially rolled tube, creating a plurality of elongated partially rolled tubes. Generally, rolling each of the strips of material into an elongated partially rolled tube comprises pulling on opposing ends of each strip of material, along a cross-grain direction of the material, and allowing the material to curl about itself. Alternatively, the strips of material may be rolled in any suitable manner, provided the requisite characteristics of the resulting elongated partially rolled tubes are present.

At step 750, the plurality of elongated partially rolled tubes are bound at a central core region. In many embodiments, the plurality of elongated partially rolled tubes may be bound by sewing each of the elongated partially rolled tubes to one another. In one embodiment, a triple stitch may be utilized for the binding process. Once bound, the resulting filamentary fabric article substantially resembles a generally spherical article when no external forces are acting thereon. The method 700 ends at step 760.

While the foregoing is directed to embodiments of the present invention, other and further embodiments of the invention may be devised without departing from the basic scope thereof. For example, although various embodiments of the present invention disclosed unique feature or elements to that embodiment, such features and elements may be combined with any other embodiment disclosed herein.

What is claimed is:

1. A filamentary fabric article consisting of:
a plurality of elongated partially rolled fabric tubes;
wherein the plurality of elongated partially rolled fabric tubes are sewn together at a central core region, and wherein the plurality of elongated partially rolled fabric tubes are provided in a sufficient density that the filamentary fabric article substantially resembles a generally spherical article when no external forces are acting thereon.

2. The filamentary fabric article of claim 1, wherein the partially rolled fabric tubes comprise a woven or non-woven, natural or synthetic fabric, or combinations thereof.

3. The filamentary fabric article of claim 2, wherein the partially rolled fabric tubes comprise stretch velour knit fabric.

4. The filamentary fabric article of claim 1, wherein the partially rolled fabric tubes are sewn together utilizing a triple stitch.

5. The filamentary fabric article of claim 1, wherein each of the plurality of elongated partially rolled fabric tubes comprise a rolled diameter at least one-fifth the size of the length of the partially rolled fabric tube.

6. The filamentary fabric article of claim 1, wherein each of the plurality of elongated partially rolled fabric tubes is capable of stretching in an axial direction away from the central core region of the filamentary fabric article.

7. The filamentary fabric article of claim 6, wherein the maximum amount of stretch is limited by the yield point of the material of the elongated partially rolled fabric tubes.

8. The filamentary fabric article of claim 1, wherein each of the plurality of elongated partially rolled fabric tubes are substantially the same length.

9. A filamentary fabric article comprising:
a plurality of elongated partially rolled tubes made of a stretch velour knit fabric, each of the plurality of elongated partially rolled tubes having an unrolled width of about one inch to about two inches wide;
wherein the plurality of elongated partially rolled tubes are sewn together using a triple stitch at a central core region, and wherein the plurality of elongated partially rolled fabric tubes are provided in a sufficient density that the filamentary fabric article substantially resembles a generally spherical article when no external forces are acting thereon.

10. The filamentary fabric article of claim 9, wherein each of the plurality of elongated partially rolled tubes comprise a rolled diameter at least one-fifth the size of the length of the partially rolled tube.

11. The filamentary fabric article of claim 9, wherein each of the plurality of elongated partially rolled tubes is rolled about an axis in the cross-grain direction of the fibers of the stretch velour knit fabric.

12. The filamentary fabric article of claim 11, wherein each of the plurality of elongated partially rolled tubes is capable of stretching in an axial direction away from the central core region of the filamentary fabric article.

13. The filamentary fabric article of claim 12, wherein the maximum amount of stretch is limited by the yield point of the material of the elongated partially rolled tubes.

14. The filamentary fabric article of claim 9, wherein each of the plurality of elongated partially rolled tubes are substantially the same length.

15. A method of manufacturing a filamentary fabric article comprising:
providing a blank of material;
cutting the blank of material into strips of material, each strip of material having a width of between about one-quarter inch to about twelve inches;
rolling each of the strips of material into an elongated partially rolled tube, creating a plurality of elongated partially rolled tubes; and
binding the plurality of elongated partially rolled tubes at a central core region;
wherein the plurality of elongated partially rolled fabric tubes are provided in a sufficient density that the resulting filamentary fabric article substantially resembles a generally spherical article when no external forces are acting thereon.

16. The method of claim 15, wherein the blank of material comprises a woven or non-woven, natural or synthetic fabric, or combinations thereof.

17. The method of claim 16, wherein the blank of material comprises stretch velour knit fabric.

18. The method of claim 15, wherein rolling each of the strips of material into an elongated partially rolled tube comprises pulling on opposing ends of each strip of material, along a cross-grain direction of the material, and allowing the material to curl about itself.

19. The method of claim 15, wherein binding the plurality of elongated partially rolled tubes comprises sewing the plurality of elongated partially rolled tubes together at the central core region.

20. The method of claim 19, wherein a triple stitch is used to sew the plurality of elongated partially rolled tubes together at the central core region.
